(19) United States
(12) Patent Application Publication
(10) Pub. No.: US 2023/0383018 A1
(43) Pub. Date: Nov. 30, 2023

(54) POLYMERS WITH SULFUR CONTAINING END GROUPS

(71) Applicant: Arlanxeo Deutschland GmbH, Dormagen (DE)

(72) Inventor: Norbert STEINHAUSER, Dormagen (DE)

(73) Assignee: Arlanxeo Deutschland GmbH, Dormagen (DE)

(21) Appl. No.: 18/032,672

(22) PCT Filed: Oct. 18, 2021
(86) PCT No.: PCT/EP2021/078739

§ 371 Date: Apr. 19, 2023

(30) Foreign Application Priority Data
Oct. 19, 2020 (EP) 20202665.4

(51) Int. Cl. C08C 19/20; C08F 2/26; C08F 236/06; C08F 236/10; C08C 19/25

(52) U.S. Cl. CPC C08C 19/20; C08F 2/26; C08F 236/06; C08F 236/10; C08C 19/25; C08F 2810/40; B60C 1/0016

(57) ABSTRACT

A process for making a functionalized diene polymer terminated by a functional end group selected from thiol containing end groups, thiolate containing end groups and a combination thereof, comprising
(i) preparing a diene polymer by a polymerization reaction comprising an anionic polymerization reaction;
(ii) adding at least one first functionalisation reagent according to formula (III)

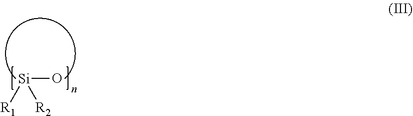

to the polymerization reaction and reacting the at least one first functionalisation reagent with the anionic chain ends of the diene polymer to obtain a first reaction product,
(iii) adding at least one second functionalising reagent (IV)

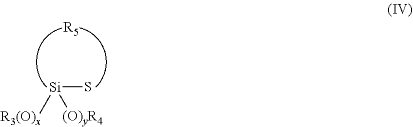

to the first reaction product to produce a thiol-terminated or thiolate-terminated diene polymer; wherein the process, optionally, further comprises
(iv) isolating the thiol-terminated or thiolate-terminated diene polymer from the reaction mixture, and optionally further comprising
(v) bringing the diene polymer into the form of sheets, bales, granules, bales or into the form of a powder,
wherein the thiol-terminated or thiolate-terminated diene polymer contains at least 51% by weight based on the total weight of the polymer of units derived from 1,3-butadiene, and wherein in formula (III) and (IV) R₁, R₂, R₃ and R₄ represent, independently from each other, hydrogen or a hydrocarbon residue containing from 1 to 24 carbon atoms per unit n and wherein the hydrocarbon residue may be saturated or may contain at least one carbon-carbon double bond and wherein the hydrocarbon residue may be interrupted once or more than once by O, Si or S atoms and may contain one or more substituents selected from alkyl amino, alkyl phosphino, alkyl silyl substituents and combinations thereof;
R₅ represents an alkylene group —[CXY]ₚ— wherein p is an integer selected from 2, 3, 4 or 5 and X and Y are independent from each other selected from H, or C₁-C₆ alkyl and each X and Y may be the same or different in each unit p, or the alkylene group is unsaturated in which case two neighbouring X, or two neighbouring Y, or one neighbouring X and one neighbouring Y jointly represent a carbon-carbon double bond;
n represents 3, 4, 5, 6, 7 or 8;
x and y are selected independently from each other and either represent 0 or 1 with the proviso that the sum of x+y is either 1 or 2. Also provided are polymers obtained by the process, compositions and compounds containing the polymers and articles made from the compounds. Also provided are methods of making compounds and articles.

### BACKGROUND

Important properties of tires are good adhesion to dry and wet surfaces, low rolling resistance and high abrasion resistance. Since it is very difficult to provide a single material having all required properties, mixtures of different rubbers are used in tire compositions together with fillers or mixtures of different fillers.

Diene-based polymers like butadiene homopolymers and copolymers are typically used as a rubber component of tire compositions for reducing the rolling resistance because of their good dynamic mechanical properties. It is known that the rolling resistance of tires can be further reduced by improving the interactions of the diene polymers with other components of tire compositions, for example by introducing functional groups at the polymer chain ends. Numerous methods for end-group modification of diene rubbers with various chemically different end groups are known.

Butadiene and butadiene-styrene polymers having thiol end groups are reported to provide compounds with improved dynamic mechanical properties because most tire compositions contain-sulfur based curing agents that may favorably interact with thiol end groups.

In international patent application WO 2007/047943 A2 homopolymers of 1,3-butadiene and butadiene-styrene copolymers are described that are end-group functionalized with silane-sulfide groups according to the general formula:

(RO)ₓ(R)_{y}Si—R′—S—SiR₃,

wherein Si represents silicon, S, represents sulfur, O represents oxygen, x is an integer selected from 1, 2 and 3, y is an integer selected from 0, 1, and 2 and the sum of x+y is 3. Each R represents a C1-C16 alkyl group and R′ represents an aryl, alkyl aryl or a C1-C16 alkyl. Compounds made with such end-group modified polymers were reported to have improved dynamic mechanic properties. Free thiol end groups were generated after cleaving off the protective —SiR₃ group. However, the presence of trialkyl silanols generated by cleaving off the protective —SiR₃ groups may be undesired and the trialkyl silanols may have to be removed in an additional process step, which is uneconomical.

In WO 2011/059917 A1 polymers with free thiol end groups were created by reacting the active terminal chain ends of the polymers with 1-thia-2-silocyclopentanes. Due to reactions of living anionic chains end with the functionalization reagent the degree of chain coupling can be high. This is disadvantageous because it reduces the number of thiol-functionalized polymer chain-ends.

There was a need to provide alternative functionalization reagents for generating diene polymers with thiol end groups.

### SUMMARY

In one aspect of the present disclosure there is provided a process for making a functionalized diene polymer terminated by a functional end group selected from thiol containing end groups, thiolate containing end groups and a combination thereof, comprising
(i) preparing a diene polymer by a polymerization reaction that produces anionic chain ends;
(ii) adding at least one first functionalisation reagent according to formula (III)

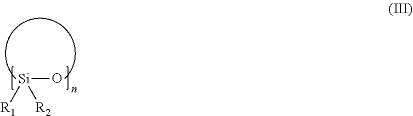

to the polymerization reaction and reacting the at least one first functionalisation reagent with the anionic chain ends of the diene polymer to obtain a first reaction product,
(iii) adding at least one second functionalising reagent (IV)

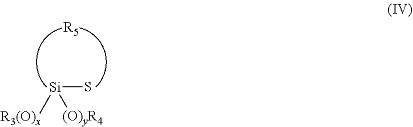

to the first reaction product to produce a thiol-terminated or thiolate-terminated diene polymer; wherein the process, optionally, further comprises
(iv) isolating the thiol-terminated or thiolate-terminated diene polymer from the reaction mixture, and optionally further comprising
(v) bringing the diene polymer into the form of sheets, bales, granules, bales or into the form of a powder,
wherein the diene polymer contains at least 51% by weight based on the total weight of the polymer of units derived from 1,3-butadiene, and wherein in formula (III) and (IV) R₁, R₂, R₃ and R₄ represent, independently from each other and from each unit n, hydrogen or a hydrocarbon residue containing from 1 to 24 carbon atoms and wherein the hydrocarbon residue may be saturated or may contain at least one carbon-carbon double bond and wherein the hydrocarbon residue may be interrupted once or more than once by O, Si or S atoms and may contain one or more substituents selected from alkyl amino, alkyl phosphino, alkyl silyl substituents and combinations thereof;
R₅ represents an alkylene group —[CXY]ₚ— wherein p is an integer selected from 2, 3, 4 or 5 and X and Y are selected independently from each other from H, or C₁-C₆ alkyl and each X and Y may be the same or different in each unit p, or the alkylene group is unsaturated in which case two neighbouring X, or two neighbouring Y, or one neighbouring X and one neighbouring Y jointly represent a carbon-carbon double bond;
n represents 3, 4, 5, 6, 7 or 8;
x and y are selected independently from each other and either represent 0 or 1 with the proviso that the sum of x+y is either 1 or 2.

In another aspect of the present disclosure there is provided a functionalized diene polymer obtainable by the process.

In a further aspect of the present disclosure there is provided a composition comprising at least 90% by weight based on the total weight of the composition of the functionalized diene polymer.

In yet another aspect of the present disclosure there us provided a curable compound comprising at least 5% by weight based on the total weight of the compound of the functionalized diene polymer as defined in any one of claims 1 to 10 and further comprising at least 10% by weight based on the total weight of the compound of at least one rubber other than the functionalized polymer, at least one filler or a combination thereof and wherein the curable compound, optionally, further comprises at least one curative for curing the functionalized butadiene polymer.

In a further aspect of the present disclosure there is provided a method of making the compound comprising combining at least one functionalized diene polymer with at least one filler or at least one rubber other than the functionalized diene polymer, or a combination thereof, and optionally at least one curative for curing the functionalized diene polymer.

In yet another aspect of the present disclosure there is provided an article comprising the compound in a cured form, wherein the article preferably is a tire or a rubber component of a tire.

In a further aspect of the present disclosure there is provided a method of making an article comprising subjecting the curable compound to curing and shaping wherein the shaping may be carried out prior to, after or during the curing.

### DETAILED DESCRIPTION

The present disclosure will be further illustrated in the following detailed description. In the following description certain standards (ASTM, DIN, ISO etc.) may be referred to. If not indicated otherwise, the standards are used in the version that was in force on Oct. 1, 2020. If no version was in force at that date because, for example, the standard has expired, then the version is referred to that was in force at a date that is closest to Oct. 1, 2020.

In the following description the amounts of ingredients of a composition or a polymer may be indicated interchangeably by “weight percent”, “wt. %” or “% by weight”. The terms “weight percent”, “wt. %” or “% by weight” are based on the total weight of the composition or polymer, respectively, which corresponds to 100%, unless described otherwise.

The term “phr” means “parts by weight per hundred parts by weight of rubber”. This term is used in rubber compounding to base the amounts of ingredients of a rubber composition on the total amount of rubber in the rubber compound. The amount of one or more ingredients of a composition (parts by weight of the one or more ingredient) are based on 100 parts by weight of rubber.

Ranges identified in this disclosure are meant to include and disclose all values between the endpoints of the range and its end points, unless stated otherwise.

The term “comprising” is used in an open, non-limiting meaning. The phrase “a composition comprising ingredients A and B” is meant to include ingredients A and B but the composition may also have additional ingredients. Contrary to the use of “comprising” the word “consisting” is used in a narrow, limiting meaning. The phrase “a composition consisting of ingredients A and B” is meant to describe a composition containing only the ingredients A and B and no additional ingredients.

Functionalized Diene Polymers

Typically, the diene according to the present disclosure are rubbers. Rubbers typically have a glass transition temperature below 20° C.

The diene polymers according to the present disclosure are curable and can be cured to produce articles or components of articles. Articles produced with the diene rubbers typically contain the rubbers in their cured form.

The diene polymers preferably are butadiene polymers and include homopolymers and copolymers of 1,3-butadiene. Preferably, the polymers according to the present disclosure contain at least 51% by weight, preferably at least 60% by weight, based on the weight of the polymer, of units derived from 1,3-butadiene. In one embodiment of the present disclosure the diene polymers contain at least 60% by weight, or at least 75% by weight units derived from 1,3-butadiene.

In one embodiment of the present disclosure the diene polymers contain from 0 to 49% by weight, or from 0% to 40% by weight, based on the total weight of the polymer, of units derived from one or more comonomers.

In one embodiment of the present disclosure the diene polymers contain at least 60% by weight, or at least 70% by weight units derived from 1,3-butadiene and from 0 to 40% by weight, or from 0 to 30% by weight of units derived from one or more comonomers.

Suitable comonomers include, but are not limited to, conjugated dienes, preferably having from 5 to 24, more preferably from 5 to 20 carbon atoms.

Specific examples of conjugated dienes include, but are not limited to isoprene, 1,3-pentadiene, 2,3-dimethylbutadiene, 1-phenyl-1,3-butadiene, 1,3-hexadiene, myrcene, ocimene, farnesene and combinations thereof.

In one embodiment the diene polymers of the present disclosure contain from 0 to 20% by weight of units derived from one or more conjugated dienes other than 1,3 butadiene.

Suitable comonomers also include vinylaromatic comonomers, preferably vinyl aromatic comonomers having from 8 to 30 carbon atoms. Specific examples of vinylaromatic comonomers include, but are not limited to, styrene, ortho-methylstyrene, meta-methylstyrene, para-methylstyrene, para-butylstyrene, vinylnaphthalene, divinylbenzene, trivinylbenzene, divinylnaphthalene and combinations thereof.

In one embodiment the diene polymers according to the present disclosure contain up to 49% by weight of units derived from one or more vinylaromatic comonomer, preferably from 5% to 40% by weight of units derived from one or more vinylaromatic comonomer.

Preferably, the diene polymers of the present disclosure contain up to 49% by weight, based on the weight of the polymer, or from 0 to 40% by weight, of units derived from styrene.

Suitable comonomers further include one or more alpha-olefins, for example, ethene, propene, 1-butene, 1-pentene, 1-hexene, 4-methyl-1-pentene,1-octene and combinations thereof.

In one embodiment, the diene polymers according to the present disclosure contain from 0 to 20% by weight of units derived from ethene, propene, 1-butene, 1-pentene, 1-hexene, 4-methyl-1-pentene,1-octene and combinations thereof.

Suitable comonomers also include, but are not limited to, one or more other co-polymerizable comonomers that introduce functional groups including cross-linking sites, branching sites, branches or functionalized groups. In one embodiment of the present disclosure the diene polymers contain from 0% to 10% by weight or from 0% to 5% by weight of units derived from one or more of such other comonomers.

Combinations of one or more of the comonomers of the same chemical type as described above as well as combinations of one or more comonomers from different chemicals types may be used.

The diene polymers according to the present disclosure may have a Mooney viscosity ML 1+4 at 100° C. of from 10 to 200 Mooney units, for example from 30 to 150 or from 35 to 85 Mooney units.

The diene polymers according to the present disclosure may have a number-averaged molecular weight (Mn) of from 10,000 g/mole to 2,000,000 g/mole, or from 100,000 to 1,000,000 g/mole, for example from 100,000 to 400,000 g/mole or from 200,000 to 300,000 g/mole. In one embodiment of the present disclosure, the polymers have an Mn of from 150 kg/mole to 320 kg/mole.

The diene polymers according to the present disclosure may have a molecular weight distribution (MWD) from 1.0 to 15, for example from 1.0 to 5. In one embodiment of the present disclosure the polymers have an MWD of from 1.0 to 3.5 or from 1.0 to 2.0. The MWD is the ratio of the weight-averaged molecular weight (Mw) to the number averaged molecular weight Mn, i.e., MWD equals Mw/Mn.

The diene polymers according to the present disclosure may have a glass transition temperature (Tg) of from −120° C. to less than 20° C. In a preferred embodiment of the present disclosure the polymers have a Tg of from 0° C. to −110° C. or from −10° C. to −80° C. In one embodiment of the present disclosure the butadiene polymer has a glass transition temperature of from about −10 to −70° C.

In one embodiment of the present disclosure the diene polymers have a number-averaged molecular weight of from 100,000 to 1,000,000 and a Mooney viscosity ML 1+4 at 100° C. of from 30 to 150 units and a glass transition temperature of from −110° C. to 0° C.

In one embodiment the diene polymers according to the present disclosure have a Mooney viscosity ML 1+4 at 100° C. of from 30 to 150 units, a molecular weight of from 100,000 to 400,000 g/mole, a glass transition temperature of from −110° C. to 0° C. and a molecular weight distribution (MWD) from 1.0 to 20.

The diene polymers according to the present disclosure are end-group functionalized. They are obtainable by a polymerization reaction where the reactive chain ends of the polymer are reacted with a first functionalization reagent to produce as reaction product a first end-group functionalized polymer. Subsequently, this reaction product is reacted with a second functionalization reagent.

The resulting functionalized diene polymers may have thiol end groups or thiolate end groups. More specifically, the polymers may have at least one thiol end group according to formula (I)

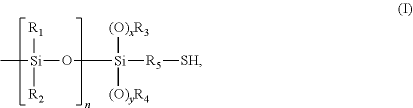

or at least a thiolate end group according to the general formula (II)

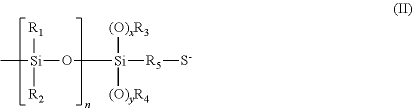

or a combination thereof.

Preferably, the functional end groups are directly connected to the polymer back bone.

Functionalized diene polymers obtained by this sequential reaction with the first and second functionalization reagents can be also represented by formula (IA) or formula (IIA) or a combination thereof:

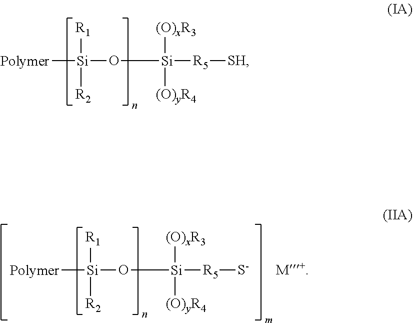

In formula “Polymer” represents a diene polymer described and (I), (IA), (II) and (IIA) R₁, R₂, R₃ and R₄ represent, independently from each other, and independent from each unit n and m as the case may be, a hydrogen or a hydrocarbon residue containing from 1 to 24 carbon atoms per unit and wherein the hydrocarbon residue may be saturated or may contain at least one carbon-carbon double bond and wherein the hydrocarbon residue may be interrupted once or more than once by O, Si or S atoms and may contain one or more substituents selected from alkyl amino, alkyl phosphino, alkyl silyl substituents and combinations thereof;
R₅ represents an alkylene group —[CXY]ₚ— wherein p is an integer selected from 2, 3, 4 or 5 and X and Y are independent from each other selected from H, C₁-C₆ alkyl and each X and Y may be the same or different in each unit p, or the alkylene group may be unsaturated in which case two neighbouring X, or two neighbouring Y, or one neighbouring X and one neighbouring Y jointly represent a carbon-carbon double bond;
n is selected from 1, 2, 3, 4, 5, 6, 7 or 8;
x and y are selected independently from each other and either represent 0 or 1 with the proviso that the sum of x+y is either 1 or 2, preferably x and y are both 1;

In formula (II) and (IIA) m represents 1, 2, 3 or 4 and M represents a metal or semi-metal with the valency indicated by m and m is an integer from 1 to 4, i.e. 1, 2, 3 or 4. Examples of suitable metals or semi-metals include Li, Na, K, Mg, Ca, Zn, Fe, Co, Ni, Al, Nd, Gd, Ti, Sn, Si, Zr, V, Mo or W and preferably include Li, Na, K, Mg and Ca.

The residues R₁, R₂, R₃ and R₄ may be saturated or unsaturated, aliphatic or aromatic, linear or branched or aliphatic and cyclic. In one embodiment of the present disclosure R₁, R₂, R₃ and R₄ represent, independently from each other, H or an aliphatic hydrocarbon residue having from 1 to 20 carbon atoms, which may be aliphatic or aromatic, linear or branched. For aromatic residues the minimum number of carbon atoms is 6. In another embodiment of the present disclosure R₁, R₂, R₃ and R₄ are selected, independently from one another, from H, methyl, ethyl, n-propyl, isopropyl, n-butyl and isobutyl. In one embodiment of the present disclosure at least two R₁, R₂, R₃ and R₄ are methyl and preferably R₁, R₂, R₃ and R₄ are all methyl.

In one embodiment of the present disclosure n is selected from 3, 4 and 5, preferably 4. In embodiment of the present disclosure n is selected from 3, 4 and 5, preferably 4 and R₁, R₂, R₃ and R₄ represent, independently from one another, H or an aliphatic hydrocarbon residue having from 1 to 6 carbon atoms, preferably R₁, R₂, R₃ and R₄ are selected, independently from one another, from H, methyl, ethyl, n-propyl, isopropyl, n-butyl and isobutyl. Preferably R₁, R₂, R₃ and R₄ are all methyl, ethyl or propyl, and more preferably at least two R₁, R₂, R₃ and R₄ are methyl and most preferably R₁, R₂, R₃ and R₄ are all methyl.

In one embodiment of the present disclosure R₅ represents a linear or branched hydrocarbon residue having from 2 to 12 carbon atoms, preferably a saturated hydrocarbon residue having 3 or 4 carbon atoms. Preferably R₅ is selected from —(CH₂)ₚ— with p being 2, 3, 4 or, more preferably p is 3 or 4.

In one embodiment of the present disclosure R₁ and R₂ are selected, independently from each other, from H, C₁-C₃ alkyl, vinyl, allyl, phenyl; n is 3, 4 or 5; R₃ and R₄ are selected independently from each other from H, C₁-C₄ alkyl, vinyl, allyl, phenyl, or an alkyl phenyl residue with not more than 20 carbon atoms, and R₅ is selected from —(CH₂)ₚ— with p being 3 or 4.

In another embodiment of the present disclosure R₁, R₂, R₃ and R₄ are selected independently from each other from hydrogen, methyl, ethyl or propyl, x and y are both 1, n is 3 or 4, and R₅ is selected from —(CH₂)ₚ— with p being 3 or 4.

The end group functionalized diene rubbers according to the invention are obtainable by the polymerization of butadiene with or without the comonomers and sequential reaction with the first and second functionalization reagents as will be described below.

Process of Making the Functionalized Diene Polymers

The diene polymers according to the present disclosure can be obtained by anionic polymerization or by polymerization using coordination catalysts. Coordination catalysts in this context include Ziegler-Natta catalysts and monometallic catalyst systems. Preferred coordination catalysts include those based on Ni, Co, Ti, Zr, Nd, Gd, V, Cr, Mo, W or Fe. Preferably, the polymers are obtained by a polymerization comprising anionic polymerization.

The anionic polymerization of diene polymers is known in the art. Suitable initiators for anionic solution polymerization include organo alkali metal compounds and organo alkaline earth metal compounds. Specific examples of initiators include methyllithium, ethyllithium, isopropyllithium, n-butyllithium, sec-butyllithium, pentyllithium, n-hexyllithium, cyclohexyllithium, octyllithium, decyl-lithium, 2-(6-lithio-n-hexoxy)tetrahydropyran, 3-(tert-butyldimethylsiloxy)-1-propyllithium, phenyllithium, 4-butylphenyllithium, 1-naphthyllithium, p-toluyllithium and allyllithium compounds, initiators derived from tertiary N-allylamines such as [1-(dimethylamino)-2-propenyl]lithium, [1-[bis(phenylmethyl)amino]-2-propenyl]lithium, [1-(diphenylamino)-2-propenyl]lithium, [1-(1-pyrrolidinyl)-2-propenyl]lithium, Lithium amides of secondary amines such as lithium pyrrolidide, lithium piperidide, lithium hexamethylene imide, lithium 1-methyl imidazolidide, lithium 1-methyl piperazide, lithium morpholide, lithium dicyclohexylamide, lithium dibenzyl amide, lithium diphenyl amide. Di- and polyfunctional organolithium compounds can also be used, for example 1,4-dilithiobutane, dilithium piperazide. Preferred initiators include n-butyllithium and sec-butyllithium.

Controlling agents as known in the art for controlling the microstructure of the polymer, for example its content of vinyl units, may be used in the polymerization. Such agents include, for example, diethyl ether, di-n-propyl ether, diisopropyl ether, di-n-butylether, ethylene glycol dimethyl ether, ethylene glycol diethyl ether, ethylene glycol di-n-butyl ether, ethylene glycol di-tert-butyl ether, diethylene glycol dimethyl ether, diethylene glycol diethyl ether, diethylene glycol di-n-butyl ether, diethylene glycol di-tert-butyl ether, 2-(2-ethoxyethoxy)-2-methyl-propane, triethylene glycol dimethyl ether, tetrahydrofuran, ethyltetrahydrofurfuryl ether, hexyltetrahydrofurfuryl ether, 2,2-bis(2-tetrahydrofuryl)propane, dioxane, trimethylamine, triethylamine, N,N,N′,N′-tetramethyl-ethylenediamine, N-methylmorpholine, N-ethylmorpholine, 1,2-dipiperidinoethane, 1,2-dipyrrolidinoethane, 1,2-dimorpholino-ethane and potassium and sodium salts of alcohols, phenols, carboxylic acids, sulphonic acids.

Preferably, the polymerization is carried out in solution, preferably with an inert aprotic solvent. Suitable inert aprotic solvents include aliphatic saturated hydrocarbons, alkenes and aromatic hydrocarbons. Specific examples of aliphatic saturated hydrocarbons include butanes, pentanes, hexanes, heptanes, octanes, decanes and cyclopentane, methylcyclopentane, cyclohexane, methylcyclohexane, ethylcyclohexane and 1,4-dimethylcyclohexane. A specific example of a suitable alkene includes 1-butene. Specific examples of suitable aromatic hydrocarbons include benzene, toluene, ethylbenzene, xylene, diethylbenzene or propylbenzene. The solvents can be used also in combination with each other or in combination with one or more polar solvent. Preferred solvents include cyclohexane, methylcyclopentane and n-hexane.

Generally, the solvents may be used in a quantity of about 100 to about 1000 g, preferably from 200 to 700 g, per 100 g of monomer.

Preferably, the polymerization is carried out by introducing monomers and solvent and then starting the polymerization by adding the polymerization initiator and activating it if necessary. Other known methods for carrying out the polymerization may also be used, for example continuously feeding at least one feed stream comprising solvent, monomer and initiator into the reactor vessel and continuously feeding at least one product stream out of the reactor vessel. The polymerization can be carried out as batch polymerization or as continuous polymerization.

Typically, the reaction is carried out at a pressure between 1 to 10 bar. Typical reaction pressures include 3-8 bar.

The molecular weight, the molecular weight distribution and the Mooney viscosity of the polymers can be controlled as known in the art, for example by using chain transfer agents or controlling monomer feed, amounts of initiators, reaction speed and the like as known to the skilled polymer chemist. The glass transition temperature of the polymers can be controlled, for example, by the composition and amounts of monomers and comonomers.

The anionic polymerization reaction creates active anionic chain ends. At least one first functionalization reagent is added to the reaction mixture that reacts with the anionic chain ends of the polymer to provide a first end-group functionalized polymer as reaction product. Subsequently at least one second functionalization reagent is added to the reaction product and reacts with it to generate the thiol-terminated or thiolate-terminated polymer according to the present disclosure.

The first functionalization reagent preferably is a cyclosiloxane. Suitable cyclosiloxanes correspond to the general formula (III):

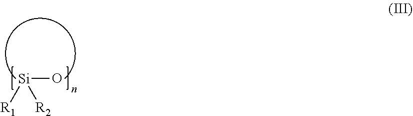

where
n represents 3, 4, 5, 6, 7, or 8,
and wherein R₁, R₂ are identical or different from each other and have the same meaning as described above with respect to formula (I), (IA), (II) and (IIA) above and including the specific and preferred embodiments mentioned above.

In a particular embodiment of the present disclosure in formula (II) R₁ is methyl or ethyl, R₂ is selected from hydrogen, methyl, ethyl, phenyl and vinyl (—CH═CH₂) and n is 3, 4, or 5. In another particular embodiment of the present disclosure R₁ and R₂ are both hydrogen and n is 3, 4 or 5.

Specific examples of suitable cyclosiloxanes according to formula (III) include, but are not limited to; 2,2,4,4,6,6-hexamethylcyclotrisiloxane, 2,2,4,4,6,6,8,8-octamethylcyclotetrasiloxane, 2,2,4,4,6,6,8,8,10,10-decamethylcyclopentasiloxane, 2,2,4,4,6,6,8,8,10,10,12,12-dodecamethylcyclohexasiloxane, 2,4,6-trimethyl-2,4,6-trivinylcyclotrisiloxane, 2,4,6-trimethyl-2,4,6-triphenylcyclotrisiloxane, 2,4,6-trimethylcyclotrisiloxane, cyclotrisiloxane, 2,4,6,8-tetramethyl-2,4,6,8-tetravinylcyclotetrasiloxane, 2,4,6,8-tetramethyl-2,4,6,8-tetraphenylcyclotetrasiloxane, 2,4,6,8-tetramethylcyclotetrasiloxane, 2,2,4,4,6,6-hexaphenylcyclotrisiloxane, 2,2,4,4,6,6,8,8-octaphenylcyclotetrasiloxane, 2,4,6,8,10-pentamethylcyclopentasiloxane, 2,4,6,8,10-pentamethyl-2,4,6,8,10-pentavinylcyclopentasiloxane, 2,4,6,8-tetraethylcyclotetrasiloxane, 2,4,6,8-tetramethyl-2,4,6,8-tetrakis(2-diphenylphoshinoethyl)cyclotetrasiloxane.

Preferred examples include but are not limited to 2,2,4,4,6,6-hexamethylcyclotrisiloxane and 2,2,4,4,6,6,8,8-octamethylcyclotetrasiloxane.

The first functionalization reagent may be added as such or in solution or suspension. Two or more different functionalization reagents according to the general formula (III) may be added, for example simultaneously or sequentially. The first functionalization reagent is added preferably towards the end of the polymerization when the polymer chain ends are still reactive, for example when at least 90% of the monomers have been consumed and preferably after 99% of monomers have been consumed. The reaction of the at least one first functionalization reagent of formula (III) with the reactive polymer chain ends can be carried out at the same temperature that was used for the polymerization reaction, i.e. there may be no need to raise or lower the temperature of the reaction mixture prior, during or after the addition. The temperature of the reaction mixture may be raised or lowered if desired for example to increase or decrease or to control the speed of the reaction with the first functionalization reagent.

Preferably, the first functionalization reagent is added in amounts such that all reactive polymer chain ends can react with it but it may be desired in some occasions to add the reagent in smaller amounts, for example if the variation of different chain ends is to be kept high. Typical amounts correspond to 0.2 to 2 molar equivalents of functionalization reagent, based on the total molar amount of initiator employed for the polymerization. Preferably, the total amount of cyclosiloxanes according to formula (III) corresponds to 0.1 to 1.5 molar equivalents of the total molar amount of initiator employed for the polymerization.

In a subsequent step at least one second functionalization reagent is added to the reaction mixture containing the reaction product, i.e., the first end group functionalized polymer. The second functionalization reagent reacts with first end group functionalized polymer to generate the thiol-terminated or thiolate-terminated diene polymer according to the present disclosure. Preferably, the second functionalization reagent is added to the reaction mixture after the reaction of the polymer chain ends with the first reaction agent has been completed, but the addition may also be started earlier.

Typically, the second functionalization reagent corresponds to the general formula (IV)

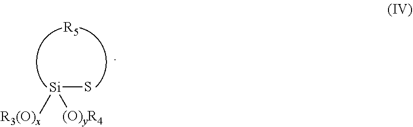

In formula (IV) the residues R₃ and R₄ are identical or different from each other and have the same meaning as described above with respect to formula (I), (II), (IA) and (IIA), and including the meaning given with respect to the specific or preferred embodiments mentioned above. R₅, x and y also have the same meaning as described above including the meaning given with respect to the specific or preferred embodiments mentioned above.

In a particular embodiment of the present disclosure R₃ and R₄ are selected from hydrogen, methyl, ethyl, propyl, butyl, phenyl, vinyl. In a preferred embodiment x and y are both 1.

Specific examples of reagents according to formula (IV) include but are not limited to: 2,2-dimethoxy-1-thia-2-silacyclobutane, 2,2-diethoxy-1-thia-2-silacyclobutane, 2,2-di-n-propoxy-1-thia-2-silacyclobutane, 2,2-di-iso-propoxy-1-thia-2-silacyclobutane, 2,2-dibutyl-1-thia-2-silacyclobutane, 2,2-diphenoxy-1-thia-2-silacyclobutane, 2,2-divinyl-1-thia-2-silacyclobutane, 2,2-dihydroxy-1-thia-2-silacyclobutane, 2-methoxy-2-methyl-1-thia-2-silacyclobutane, 2,2-dimethoxy-1-thia-2-silacyclopentane, 2,2-diethoxy-1-thia-2-silacyclopentane, 2,2-di-n-propoxy-1-thia-2-silacyclopentane, 2,2-di-iso-propoxy-1-thia-2-silacyclopentane, 2,2-dibutyl-1-thia-2-silacyclopentane, 2,2-diphenoxy-1-thia-2-silacyclopentane, 2,2-divinyl-1-thia-2-silacyclopentane, 2,2-dihydroxy-1-thia-2-silacyclopentane, 2-methoxy-2-methyl-1-thia-2-silacyclopentane, 2,2-dimethoxy-1-thia-2-silacyclohexane, 2,2-diethoxy-1-thia-2-silacyclohexane, 2,2-di-n-propoxy-1-thia-2-silacyclohexane, 2,2-di-iso-propoxy-1-thia-2-silacyclohexane, 2,2-dibutyl-1-thia-2-silacyhexane, 2,2-diphenoxy-1-thia-2-silacyhexane, 2,2-divinyl-1-thia-2-silacyclohexane, 2,2-dihydroxy-1-thia-2-silacyclohexane, 2-methoxy-2-methyl-1-thia-2-silacyclohexane, 2,2-dimethoxy-1-thia-2-silacycloheptane, 2,2-diethoxy-1-thia-2-silacycloheptane, 2,2-di-n-propoxy-1-thia-2-silacycloheptane, 2,2-di-iso-propoxy-1-thia-2-silacycloheptane, 2,2-dibutyl-1-thia-2-silacycloheptane, 2,2-diphenoxy-1-thia-2-silacycloheptane, 2,2-divinyl-1-thia-2-silacycloheptane, 2,2-dihydroxy-1-thia-2-silacycloheptane, 2-methoxy-2-methyl-1-thia-2-silacycloheptane. Preferred examples include but are not limited to 2,2-dimethoxy-1-thia-2-silacyclopentane and 2,2-diethoxy-1-thia-2-silacyclopentane.

The second functionalization reagent may be added as such, or in solution, or in suspension. Two or more different second functionalization reagents may be added, simultaneously or sequentially. The reaction of the second functionalization reagent with the first end group functionalized polymer may ca carried out at the same temperature used for the polymerization reaction, i.e. there may be no need to raise or lower the temperature of the reaction mixture prior to, during or after the addition of the second functionalization reagent. However, the temperature may be raised or lowered if desired for example to increase or decrease or to control the speed of the reaction with the first functionalization reagent.

The second functionalization reagent may be added in an amount effective for converting all end groups of the first end group functionalized polymer into the thiol or thiolate end groups according to formula (IA) or (IIA), i.e. in equimolar amounts or in molar excess. However, it may also be desired not to convert all end groups and to add the second functionalization reagent in lower than equimolar amounts. Typically, the total amount of second functionalization reagent added may be in the range of from 0.2 to 2 molar equivalents, preferably in the range from 0.6 to 1.5 molar equivalents, based on the molar amount of first functionalization reagent used. The thiolate groups according to formula (IIA) may have to be protonated to generate the thiol group (IA), for example by treating the polymer with water or an acid, for example a carboxylic acid or HCl.

One or more coupling reagents known in the art for anionic diene polymerization can be added to the reaction mixture, in addition to the functionalization reagents formula (III) and (IV). Examples of such coupling reagents include silicon tetrachloride, tin tetrachloride, tetraalkoxysilanes, 2,2-dimethoxy-1-thia-2-silacyclopentane, (3-glycidoxypropyl)trimethoxysilane, N,N,N′,N′-tetraglycidyl-4,4′-diaminodiphenylmethane, N,N,N′,N′-tetraglycidyl-1,3-bis(aminomethyl)cyclohexane. The coupling reagents may be added before, after or simultaneous with the addition of compounds of formula (III).

After addition of the second functionalization reagent, the resulting thiol-terminated or thiolate-terminated polymers may be isolated from the solvent, for example by removing the solvent. The solvent can be removed from the reaction mixture as known in the art, for example by distillation, stripping with steam or applying a vacuum. Antioxidants as known in the art may be added, for example, before or during the work up process, preferably prior to solvent removal. Examples of suitable antioxidants include sterically hindered phenols, aromatic amines, phosphites and thioethers. Extender oils as known in the art of rubber processing and compounding may be added to the reaction mixture, preferably prior to the removal of solvent, for example for providing functionalized diene polymers that are oil-extended. Suitable extender oils include TDAE (Treated Distillate Aromatic Extract) oils, MES (Mild Extraction Solvates) oils, RAE (Residual Aromatic Extract) oils, TRAE (Treated Residual Aromatic Extract) oils and naphthenic oils.

The thiol-terminated or thiolate-terminated polymers according to the present disclosure may be shaped for storage or handling or for further processing into compounds or articles. The polymers may be shaped into forms including bales, pellets, powder, sheets or granules.

Applications

The diene polymers according to the present disclosure are curable, i.e. the polymers can be cross-linked, for example by reaction or activation of one or more curing agents, for example for producing a “vulcanizate”, i.e. a cross-linked rubber product. However, the polymers according to the present disclosure may also be provided in partially cross-linked form, which means they are cross-linked to some extent, but they can still be cross-linked further.

In one aspect of the present disclosure there is provided a composition comprising at least one functionalized diene polymer of the present disclosure. The compositions may further contain rubber auxiliaries as will be described below, or, one or more curing agent, or other ingredients and combinations thereof. Such a composition may comprise at least 90% by weight, preferably at least 96% by weight, based on the total weight of the composition, of one or more butadiene polymers according to the present disclosure. Such a composition may be in the form of a powder, in the form of granules, extruded pellets or strands, or in the form of sheets or bales. In one embodiment the composition contains at least 90% by weight, or at least 96% by weight, and the composition is free of curing agents or contains curing agents in an amount of less than 10%, preferably less than 5% or even less than 1% by weight.

Compounds

The compositions containing at least one functionalized diene polymer according to the present disclosure can be used for making rubber compounds. Rubber compounds contain more than 10% by weight, preferably more than 15% by weight, based on the total weight of the compound, of one or more filler, one or more rubber other than the rubber according to the present disclosure (“other rubber”) or a combination of one or more other rubber and one or more filler. Therefore, in another aspect of the present disclosure there are provided rubber compounds containing at least one diene polymer according to the present disclosure, preferably in an amount of at least 5% by weight based on the weight of the compound.

The rubber compounds may be, for example, in the form of a powder, in the form of granules, extruded pellets or strands, or in the form of sheets or bales. The rubber compounds may further contain one or more rubber auxiliaries and/or one or more curing agent.

Filler

Preferably, the compound comprises at least one filler, preferably a filler that is suitable for application in tires, tire components and materials for making tires. Preferably, the filler contains one or more silicon oxide, one or more carbon blacks or a combination of one or more silicon oxide and one or more carbon black. Preferably, the filler includes silica-containing particles, preferably having a BET surface area (nitrogen absorption) of from 5 to 1,000, preferably from 20 to 400 m²/g. Such fillers may be obtained, for example, by precipitation from solutions of silicates or by flame hydrolysis of silicon halides. Silica filler particles may have particle sizes of 10 to 400 nm. The silica-containing filler may also contain oxides of Al, Mg, Ca, Ba, Zn, Zr or Ti. Other examples of silicon-oxide based fillers include aluminum silicates, alkaline earth metal silicates such as magnesium silicates or calcium silicates, preferably with BET surface areas of 20 to 400 m²/g and primary particle diameters of 10 to 400 nm,

natural silicates, such as kaolin and other naturally occurring silicates including clay (layered silicas). Further examples of fillers include glass particle-based fillers like glass beads, microspheres, glass fibers and glass fiber products (mats, strands).

Polar fillers, like silica-containing fillers, may be modified to make them more hydrophobic. Suitable modification agents include silanes or silane-based compounds. Typical examples of such modifying agents include, but are not limited to compounds corresponding to the general formula (V):

(R¹R²R³O)₃Si—R⁴—X (V)

wherein each R¹, R², R³ is, independently from each other, an alkyl group, preferably R¹, R², R³ are all methyl or all ethyl, R⁴ is an aliphatic or aromatic linking group with 1 to 20 carbon atoms and X is sulfur-containing functional group and is selected from —SH, —SCN, —C(═O)S or a polysulfide group.

Instead of or in addition to silicas that have been modified as described above such modification may also take place in situ, for example during compounding or during the process of making tires or components thereof, for example by adding modifiers, preferably silanes or silane-based modifiers, for example including those according to formula (V), when making the rubber compounds.

Filler based on metal oxides other than silicon oxides include but are not limited to zinc oxides, calcium oxides, magnesium oxides, aluminum oxides and combinations thereof. Other fillers include metal carbonates, such as magnesium carbonates, calcium carbonates, zinc carbonates and combinations thereof, metal hydroxides, e.g. aluminum hydroxide, magnesium hydroxide and combinations thereof, salts of alpha-beta-unsaturated fatty acids and acrylic or methacrylic acids having from 3 to 8 carbon atoms including zinc acrylates, zinc diacrylates, zinc methacrylates, zinc dimethacrylates and mixtures thereof.

In another embodiment of the present disclosure the rubber compound contains one or more fillers based on carbon, for example one or more carbon black. The carbon blacks may be produced, for example, by the lamp-black process, the furnace-black process or the gas-black process. Preferably, the carbon back has a BET surface area (nitrogen absorption) of 20 to 200 m²/g. Suitable examples include but are not limited to SAF, ISAF, HAF, FEF and GPF blacks.

Other examples of suitable filler include carbon-silica dual-phase filler, lignin or lignin-based materials, starch or starch-based materials and combinations thereof.

In a preferred embodiment, the filler comprises one or more silicon oxide, carbon black or a combination thereof.

Typical amounts of filler include from 5 to 200 parts per hundred parts of rubber, for example, from 10 to 150 parts by weight, or from 10 to 95 parts by weight for 100 parts by weight of rubber.

Curing Agents:

Preferably the rubber compounds also contain at least one curing agent for curing the diene polymer. The curing agent is capable of crosslinking (curing) the diene polymer and is also referred to herein as “crosslinkers” or “vulcanization agent”. Suitable curing agents include, but are not limited to, sulfur, sulfur-based compounds, and organic or inorganic peroxides. In a preferred embodiment of the present disclosure the curing agent includes a sulfur. Instead of a single curing agent a combination of one or more curing agents may be used, or a combination of one or more curing agent with one or more curing accelerator or curing catalysts may be used. Examples of sulfur-containing compounds acting as sulfur-donors include but are not limited to sulfur, sulfur halides, dithiodimorpholine (DTDM), tetramethylthiuramdisulphide (TMTD), tetraethylthiuramdisulphide (TETD), and dipentamethylenthiuramtetrasulphide (DPTT). Examples of curing accelerators include but are not limited to amine derivates, guanidine derivates, aldehydeamine condensation products, thiazoles, thiuram sulphides, dithiocarbamates and thiophospahtes.

In another embodiment of the present disclosure the curing agent includes a peroxide. Examples of peroxides used as vulcanizing agents include but are not limited to di-tert.-butyl-peroxides, di-(tert.-butyl-peroxy-trimethyl-cyclohexane), di-(tert.-butyl-peroxy-isopropyl-)benzene, dichloro-benzoylperoxide, dicumylperoxides, tert.-butyl-cumyl-peroxide, dimethyl-di(tert.-butyl-peroxy)hexane and dimethyl-di(tert.-butyl-peroxy)hexine and butyl-di(tert.-butyl-peroxy)valerate. A vulcanizing accelerator of sulfene amide-type, guanidine-type, or thiuram-type can be used together with a vulcanizing agent as required. If added, the vulcanizing agent is typically present in an amount of from 0.5 to 10 parts by weight, preferably of from 1 to 6 parts by weight per 100 parts by weight of rubber.

Other Rubbers

The rubber compounds and compositions according to the present disclosure may contain one or more additional rubber other than the functionalized diene polymers according to the present disclosure (referred to herein also as “other rubbers”). Examples include butadiene rubbers of the same or different composition than the functionalized diene rubbers of the present disclosure that are not functionalized or functionalized differently.

Further examples include copolymers of one or more butadiene with C1-C4-alkyl acrylates, those with an acrylonitrile content of from 10% by weight to 40% by weight, partially or fully hydrogenated acrylonitrile rubber, ethylene-propylene-diene copolymers, natural rubber and combinations thereof. Typical amounts of the one or more other rubbers in the compound may include, for example, from 5 to 500 parts per hundred parts of the functionalized butadiene rubber according to the present disclosure.

In a preferred embodiment of the present disclosure the compound comprises at least one butadiene polymer having a content of cis units of at least 90% by weight. Such polymers are also referred to in the art as “high-cis butadienes”. Such butadiene polymers are generally obtained by using polymerization catalysts based on gadolinium, neodymium, titanium, nickel or cobalt. Butadiene polymers obtained by anionic polymerization as are the diene polymers according to the present disclosure typically have a high vinyl content, for example a content of vinyl groups of at least 10% by weight based on the weight of the polymer. The high cis-butadiene polymer may be partially hydrogenated.

In one embodiment of the present disclosure the rubber compound contains one or more of the following rubbers: at least one natural rubber, at least one polybutadiene rubber having a cis content of greater than 90 wt. % or a combination thereof.

Rubber Auxiliaries

The compositions and rubber compounds containing one or more diene polymers according to the present disclosure may contain one or more rubber auxiliaries as known in the art of rubber compounding and processing. Such further rubber auxiliaries include but are not limited to curing reaction accelerators, antioxidants, heat stabilizers, light stabilizers, processing aids, plasticizers, tackifiers, blowing agents and colorants. Processing aids include organic acids, waxes and processing oils. Examples of oils include but are not limited to MES (Mild Extraction Solvate), TDAE (Treated Distillate Aromatic Extract), RAE (Residual Aromatic Extract) and naphthenic oils and vegetable oils. Specific examples of commercial oils include those with the trade designations Nytex 4700, Nytex 8450, Nytex 5450, Nytex 832, Tufflo 2000, and Tufflo 1200. Examples of oils include functionalized oils, particularly epoxidized or hydroxylated oils.

Activators include triethanolamine, polyethylene glycol, hexanetriol. Colorants include dyes and pigments and may be organic or inorganic and include, for example, zinc white and titanium oxides.

The further rubber auxiliaries may be used in appropriate amounts depending on the intended use as known in the art. Examples of typical amounts of individual or total amounts of auxiliaries include from 0.1 wt. % to 50 wt. % based on the total weight of rubber in the compound.

For making the rubber compounds the diene polymer or the diene polymer compositions according to the present disclosure can be combined with one or more of the ingredients for making the compound, for example by blending as known in the art of rubber processing. Blending may be done, for example, by using rollers, kneaders, internal mixers and mixing extruders. The fillers are preferably admixed to the solid diene polymer or to a mixture of it with other rubbers as known in the art, for example by using a kneader. Fillers may be added as solids, or as slurry or otherwise as known in the art. Curing agents and accelerators are preferably added separately in the final mixing stage.

Vulcanizates

Rubber vulcanizates are obtainable by subjecting the rubber compounds of the present disclosure to one or more curing steps. Curing can be carried out as known in the art. Curing is commonly carried out at temperatures between 100 to 200° C., for example between 130 to 180° C. Curing may be carried out in molds under pressure. Typical pressures include pressures of 10 to 200 bar. Curing times and conditions depend on the actual composition of rubber compounds and the amounts and types of curatives and curable components.

Articles

The, diene polymers, diene polymer compositions and diene polymer compounds according to the present disclosure can be used to make articles and are particularly suitable for making tires or components of tires. The tires include pneumatic tires. The tires include tires for motor vehicles, aircrafts and electro vehicles and hybrid vehicles, i.e. vehicles that can be driven by a combustion engine or an electro engine or batteries. Typical components of tires include inner liner, treads, undertreads, carcass, and the sidewalls.

In one embodiment the diene polymers, the compositions or the compounds according to the present disclosure are used in a sealing material, for example for making O-rings, gaskets or any other seal or component of a seal.

In one embodiment the diene polymers, the compositions or the compounds according to the present disclosure are used as impact modifiers for thermoplastics including polystyrenes and styrene-acrylonitriles.

In another embodiment the diene polymers, the compositions or the compounds according to the present disclosure are used for making golf balls or components thereof.

In another embodiment the diene polymers, the compositions or the compounds according to the present disclosure are used to make shaped articles selected from profiles, membranes, damping elements and hoses.

In another embodiment the diene polymers, the compositions or the compounds according to the present disclosure are used to make shoe soles, cable sheaths, hoses, linings, for example roll linings, or belts including conveyor belts, escalator belts and drive belts.

The articles may be obtained by subjecting the curable rubber compound of the present disclosure to curing and shaping. The shaping step may take place during or after the curing step or also prior to curing step. A single curing and/or shaping step may be used or a plurality of curing and/or shaping steps may be used. During curing or shaping or both to form articles the compositions and compounds of the present disclosure can be combined with one or more additional ingredients needed for making the article.

In the following the present disclosure is further illustrated by particular embodiments and examples without, however, intending to limit the present disclosure to these specific embodiments and examples.

### EXAMPLES

The weight-average molecular weight (Mw), the number-average molecular weight Mn, the polydispersity Mw/Mn and the degree of coupling of the polymers were determined using GPC (PS (polystyrene) calibration). A modular system from Agilent, Santa Clara, CA, USA was used comprising an Agilent 1260 Refractive Index Detector, Agilent 1260 Variable Wavelength Detector, 1260 ALS autosampler, column oven (Agilent 1260 TCC), Agilent 1200 Degasser, Agilent 1100 Iso Pump and a column combination of 3 PLgel 10 μm Mixed B300×7.5 mm columns from Agilent. Tetrahydrofuran (THF) was used as solvent. Polystyrene standards from PSS Polymer Standards Service GmbH (Mainz, Germany) were used. The polymer samples dissolved in THF were filtered through syringe filters (0.45 μm PTFE membranes, diameter 25 mm). The measurements were conducted at 40° C. and with a flow rate of 1 mL/min.

The Mooney viscosity ML(1+4)100° C. was measured according to DIN 52523/52524.

The comonomer content was determined by FTIR spectroscopy on rubber films. The content of vinyl, cis and trans units in the polymer can be determined by FT-IR spectrometry using the absorbances and absorbance ratios as described in the standard ISO 12965:2000(E).

The glass transition temperature (Tg) was determined using DSC (differential scanning calometry) from the 2^{nd} heating curve at a heating rate of 20 K/min.

Compound Properties

The loss factors tan δ were measured at 0° C. and at 60° C. to determine the temperature-dependent dynamic-mechanical properties. An EPLEXOR device (Eplexor 500 N) from GABO was used for this purpose. The measurements were carried out in accordance with DIN 53513 at 10 Hz on Ares strips in the temperature range from −100° C. to 100° C. To determine the strain-dependent dynamic-mechanical properties, ΔG′ was determined as the difference between the shear modulus at 0.5% strain and the shear modulus at 15% strain as well as the maximum loss factor tan δmax. These measurements were conducted according to DIN 53513-1990 on an MTS elastomer test system on cylinder specimens (20 mm×6 mm) with 2 mm compression at a temperature of 60° C. and a measuring frequency of 10 Hz in the strain range from 0.1% to 40%.

### Example 1 (Comparative): Synthesis of Styrene-Butadiene Copolymer

An inert 20 L steel reactor was filled with 8.5 kg hexane, 6.6 mmol 2,2-bis(2-tetrahydrofuryl)-propane and 11.6 mmol n-butyllithium (as a 23% solution by weight in hexane) and heated to 38° C. The heating circuit was shut, and 1185 g of 1,3-butadiene and 315 g of styrene were added simultaneously. The polymerization was carried out under stirring for 40 minutes in total during which a peak temperature of 62° C. was reached. Ten minutes after the peak temperature had been reached, the monomer consumption was considered complete. 11.6 mmol n-octanol were added to quench the anionic polymer chain ends. The rubber solution was drained into another vessel and stabilized by adding 3 g IRGANOX 1520 (2,4-bis(octylthiomethyl)-6-methylphenol). The solvent was removed by stripping with steam. The rubber crumbs were dried at 65° C. for 16 h in a vacuum drying oven.

### Example 2 (Comparative): Functionalization of Styrene-Butadiene Copolymer by Reaction with a Cyclotetrasiloxane

The procedure described in example 1 was followed except that instead of n-octanol, the functionalization reagent 2,2,4,4,6,6,8,8-octamethylcyclotetrasiloxane was added. The functionalization reagent was added in an amount equimolar to the amount of n-butyllithium. The reactor content was stirred for 5 minutes after which the rubber solution was drained. 3 g of stabilizer (IRGANOX 1520 (2,4-bis(octylthiomethyl)-6-methylphenol)) were added before the solvent removed by stripping with steam. The rubber crumbs were dried at 65° C. for 16 h in a vacuum drying oven.

### Example 3 (Comparative): Functionalization of Styrene-Butadiene Copolymer by Reaction with a Thiasilacyclopentane

An inert 20 L steel reactor was filled with 8.5 kg hexane, 8.8 mmol 2,2-bis(2-tetrahydrofuryl)-propane and 15.1 mmol n-butyllithium (as a 23% solution by weight in hexane) and heated to 38° C. The heating circuit was closed, and 1185 g of 1,3-butadiene and 315 g of styrene were added simultaneously. The polymerization was carried out under stirring for 40 minutes during which the reactor contents reached a peak temperature of 62° C. 15.1 mmol of the functionalization reagent 2,2-dimethoxy-1-thia-2-silacyclopentane were added and the reactor content was stirred for 5 minutes. Then the rubber solution was drained, stabilized by adding 3 g Irganox® 1520 (2,4-bis(octylthiomethyl)-6-methylphenol), and the solvent was removed by stripping with steam. The rubber crumbs were dried at 65° C. for 16 h in a vacuum drying oven.

### Example 4: Functionalization of Styrene-Butadiene Copolymer by Successive Reaction with 2,2,4,4,6,6,8,8-Octamethylcyclotetrasiloxane and 2,2-Dimethoxy-1-Thia-2-Silacyclopentane

An inert 20 L steel reactor was filled with 8.5 kg hexane, 6.8 mmol 2,2-bis(2-tetrahydrofuryl)-propane and 11.8 mmol n-butyllithium (as a 23% solution by weight in hexane) and heated to 38° C. The heating circuit was closed, and 1185 g of 1,3-butadiene and 315 g of styrene were added simultaneously. The comonomers were polymerized under stirring for 40 minutes during which the reactor contents reached a peak temperature of 62° C. 11.8 mmol of 2,2,4,4,6,6,8,8-octamethylcyclotetrasiloxane were added and the reactor content was stirred for 5 minutes. 11.8 mmol of 2,2-dimethoxy-1-thia-2-silacyclopentane were added to the reaction mixture and the reactor content was stirred for 5 minutes. Then the rubber solution was drained, stabilized by adding 3 g IRGANOX 1520 (2,4-bis(octylthiomethyl)-6-methylphenol), and the solvent was removed by stripping with steam. The rubber crumbs were dried at 65° C. for 16 h in a vacuum drying oven.

The properties of the rubbers from examples 1-4 are summarized in Table 1. Table 1 shows that the degree of coupling for the polymer from example 3 (obtained via addition of thiasilacyloalkane) was above 40%. This means the amount of thiol-terminated polymer chains was below 60%. By adding thiasilacycloalkane to the polymer after it had been treated with cyclosiloxane, the degree of coupling could be reduced to below 10% and the amount of thiol-terminated polymer chains could be increased accordingly as is demonstrated by example 4.

TABLE 1
Properties of the rubbers according to Examples 1-4

| Polymer from | 1 | 2 | 3 | |
|---|---|---|---|---|
| Example | (comparative) | (comparative) | (comparative) | 4 |
| Functionalization | — | 2,2,4,4,6,6,8,8- | — | 2,2,4,4,6,6,8,8- |
| reagent according | | octamethylcyclo- | | octamethylcyclo- |
| to formula (III) | | tetrasiloxane | | tetrasiloxane |
| Functionalization | — | — | 2,2-dimethoxy- | 2,2-dimethoxy- |
| reagent according | | | 1-thia-2- | 1-thia-2- |
| to formula (IV) | | | silacyclopentane | silacyclopentane |
| Mₙ [kg/mol] | 241 | 261 | 252 | 264 |
| M_{w}/Mₙ | 1.08 | 1.24 | 1.54 | 1.27 |
| Degree of | 0 | 5 | 44 | 6.5 |
| coupling [%] | | | | |
| ML1 + 4 | 52 | 48 | 65 | 55 |
| [MU] | | | | |
| Vinyl-content | 51 | 50 | 51 | 51 |
| [wt.-%] | | | | |
| Styrene-content | 21 | 21 | 21 | 21 |
| [wt.-%] | | | | |
| Tg [° C.] | −23 | −23 | −23 | −23 |

Rubber Compounds

Tire tread rubber compounds containing the butadiene polymers of examples 1, 3 and 4 were produced with the ingredients shown in table 2. The components (except sulfur and accelerator) were mixed in a 1.5-liter kneader. Sulfur and accelerator were mixed in subsequently on a roller at 40° C. The individual steps for preparing the compound are shown in table 3.

TABLE 2
Components of tire tread rubber compounds
(Specifications in phr: parts by weight per 100 parts by weight rubber)

| | |
|---|---|
| Styrene-butadiene copolymer | 70 |
| High-cis polybutadiene (BUNA CB 24 from ARLANXEO | 30 |
| Deutschland GmbH) | |
| Silica (ULTRASIL 7000) | 90 |
| Carbon black (VULCAN J/N 375) | 7 |
| TDAE oil (VIVATEC 500) | 36.3 |
| Stearic acid (EDENOR C 18 98-100) | 2.5 |
| Antioxidant (VULKANOX ® 4020/LG from LANXESS | 2 |
| Deutschland GmbH) | |
| Antioxidant (VULKANOX ® HS/LG from LANXESS | 2 |
| Deutschland GmbH) | |
| Zink oxide (from ROTSIEGEL) | 3 |
| Light protection wax (ANTILUX 654) | 2 |
| Silane (Si 69 ® from EVONIK) | 7.2 |
| Diphenylguanidine (RHENOGRAN DPG-80) | 2.75 |
| Benzothiazolesulfenamide (RHENOGRAN TBBS-80) | 2 |
| Sulphur (Mahlschwefel 90/95 CHANCEL) | 1.6 |

TABLE 3
Preparation of rubber compounds

| Step 1: | 0 | seconds | Addition of polymers |
|---|---|---|---|
| Mixing | 30 | seconds | Addition of ⅔ silica, ⅔ silane, stearic |
| in a | | | acid, wax, antioxidant, carbon black |
| 1.5 litre | 90 | seconds | Addition of residual silica and silane |
| kneader | 150 | seconds | Addition of zinc oxide |
| | 240 | seconds | Heat up to 150° C., hold at temperature for |
| | | | 3 min |
| | 420 | seconds | Ejection |
| Step 2: | Cut the sheet three times left and right followed | | |
| Mixing | by 3 revolutions at 40° C. and a nip of 4 mm | | |
| on the | | | |
| roller | | | |
| Step 3: | 24 hours storage at 24° C. | | |
| Step 4: | 0 | seconds | Addition of the compound from step 3 |
| Mixing | 30 | seconds | Heat up to 150° C., hold at temperature for |
| in a | | | 3 min |
| 1.5 litre | 210 | seconds | Ejection |
| kneader | | | |
| Step 5: | Addition of sulphur and accelerator, cut the sheet three times | | |
| Mixing | left and right followed by 3 rounds at 40° C. and a nip of 4 mm | | |
| on the | | | |
| roller | | | |

The rubber compounds were vulcanized at 160° C. for 20 minutes. The physical properties of the corresponding vulcanizates 5-7 are listed in Table 4. The properties of the vulcanized rubber compound of comparative example 5 (made with non-functionalized styrene-butadiene copolymer) are given an index of 100. All values greater than 100 in Table 4 indicate a corresponding improvement in percent of the respective property tested over the respective property of comparative example 5.

TABLE 4
Properties of vulcanizates

| | Contains the | | | | |
|---|---|---|---|---|---|
| Vulcanizate | polymer from | Tan δ at | Tan δ at | Tan δ | |
| Example | Example | 0° C. | 60° C. | Maximum | ΔG′ |
| 5 (comparative) | 1 (polymer with | 100 | 100 | 100 | 100 |
| | no functional | | | | |
| | end groups) | | | | |
| 6 (comparative) | 3 (polymer | 104 | 110 | 106 | 137 |
| | functionalized | | | | |
| | only with | | | | |
| | thiasilacompond | | | | |
| | of formula (III)) | | | | |
| 7 | 4 (polymer | 125 | 135 | 112 | 162 |
| | functionionalized | | | | |
| | first with | | | | |
| | cyclosiloxane of | | | | |
| | formula (III) and | | | | |
| | then with thiasila | | | | |
| | compound of | | | | |
| | formula (IV)) | | | | |

The loss factor tan δ at 60° C. from the temperature-dependent dynamic-mechanical measurement, the tan δ maximum and the modulus difference G′ between low and high strain from the strain-dependent dynamic-mechanical measurements are indicators for the rolling resistance of a tire.

The loss factor tan δ at 0° C. is an indicator for the wet slip resistance of the tire.

As can be seen from Table 4, functionalization of the butadiene polymer with a thiol-terminated end group lead to a vulcanizate having improved values for the wet grip indicator and the rolling resistance indicators as revealed by a comparison of comparative examples 5 and 6. By using the thiol-terminated butadiene polymers according to the present disclosure containing a silicone spacer unit between polymer chain end and thiol end group the wet grip indicator and the rolling resistance indicators of the vulcanizate can be improved further (as demonstrated in example 7).

1. A process for making a functionalized diene polymer terminated by a functional end group selected from thiol containing end groups, thiolate containing end groups and a combination thereof, comprising
(i) preparing a diene polymer by a polymerization reaction that produces anionic chain ends;
(ii) adding at least one first functionalisation reagent according to formula (III) 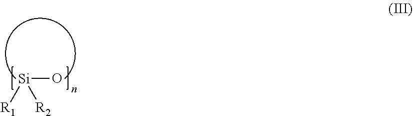
to the polymerization reaction and reacting the at least one first functionalisation reagent with the anionic chain ends of the diene polymer to obtain a first reaction product,
(iii) adding at least one second functionalising reagent (IV) 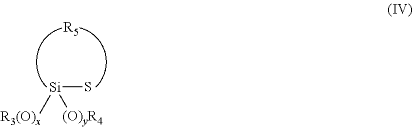
to the first reaction product to produce a thiol-terminated or thiolate-terminated diene polymer; wherein the process, optionally, further comprises
(iv) isolating the thiol-terminated or thiolate-terminated diene polymer from the reaction mixture, and optionally further comprising
(v) bringing the diene polymer into the form of sheets, bales, granules, bales or into the form of a powder,
wherein the thiol-terminated or thiolate-terminated diene polymer contains at least 51% by weight based on the total weight of the polymer of units derived from 1,3-butadiene, and wherein in formula (III) and (IV) R₁, R₂, R₃ and R₄ represent, independently from each other and from each unit n, hydrogen or a hydrocarbon residue containing from 1 to 24 carbon atoms and wherein the hydrocarbon residue may be saturated or may contain at least one carbon-carbon double bond and wherein the hydrocarbon residue may be interrupted once or more than once by O, Si or S atoms and may contain one or more substituents selected from alkyl amino, alkyl phosphino, alkyl silyl substituents and combinations thereof;
R₅ represents an alkylene group —[CXY]ₚ— wherein p is an integer selected from 2, 3, 4 or 5 and X and Y are selected independently from each other from H, or C₁-C₆ alkyl and each X and Y may be the same or different in each unit p, or the alkylene group is unsaturated in which case two neighbouring X, or two neighbouring Y, or one neighbouring X and one neighbouring Y jointly represent a carbon-carbon double bond;
n represents 3, 4, 5, 6, 7 or 8;
x and y are selected independently from each other and either represent 0 or 1 with the proviso that the sum of x+y is either 1 or 2.

2. The process of claim 1 wherein R₅ is selected from —(CH₂)ₚ— with p being 3 or 4.

3. The process of claim 1, wherein in formula (III) and (IV) R₁ and R₂ are selected, independently from each other, from H, C₁-C₃ alkyl, vinyl, allyl, phenyl, n is 3, 4 or 5; R₃ and R₄ are selected independently from H, C₁-C₄ alkyl, vinyl, allyl, phenyl, or alkyl phenyl with not more than 20 carbon atoms and R₅ is selected from —(CH₂)ₚ— with p being 3 or 4.

4. The process of claim 1, wherein in formula (III) and (IV) R₁, R₂, R₃ and R₄ are selected independently from each other, from hydrogen, methyl, ethyl or propyl, x and y are both 1, n is 3 or 4, and R₅ is selected from —(CH₂)ₚ— with p being 3 or 4.

5. The process of claim 1, wherein the first functionalisation reagent is selected from 2,2,4,4,6,6-hexamethylcyclotrisiloxane, 2,2,4,4,6,6,8,8-octamethylcyclotetrasiloxane, 2,2,4,4,6,6,8,8,10,10-decamethylcyclopentasiloxane, 2,2,4,4,6,6,8,8,10,10,12,12-dodecamethylcyclohexasiloxane, 2,4,6-trimethyl-2,4,6-trivinylcyclotrisiloxane, 2,4,6-trimethyl-2,4,6-triphenylcyclotrisiloxane, 2,4,6-trimethylcyclotrisiloxane, cyclotrisiloxane, 2,4,6,8-tetramethyl-2,4,6,8-tetravinylcyclotetrasiloxane, 2,4,6,8-tetramethyl-2,4,6,8-tetraphenylcyclotetrasiloxane, 2,4,6,8-tetramethylcyclotetrasiloxane, 2,2,4,4,6,6-hexaphenylcyclotrisiloxane, 2,2,4,4,6,6,8,8-octaphenylcyclotetrasiloxane, 2,4,6,8,10-pentamethylcyclopentasiloxane, 2,4,6,8,10-pentamethyl-2,4,6,8,10-pentavinylcyclopentasiloxane, 2,4,6,8-tetraethylcyclotetrasiloxane, 2,4,6,8-tetramethyl-2,4,6,8-tetrakis(2-diphenylphoshinoethyl)cyclotetrasiloxane.

6. The process of claim 1, wherein the second functionalization reagent is selected from 2,2-dimethoxy-1-thia-2-silacyclobutane, 2,2-diethoxy-1-thia-2-silacyclobutane, 2,2-di-n-propoxy-1-thia-2-silacyclobutane, 2,2-di-iso-propoxy-1-thia-2-silacyclobutane, 2,2-dibutyl-1-thia-2-silacyclobutane, 2,2-diphenoxy-1-thia-2-silacyclobutane, 2,2-divinyl-1-thia-2-silacyclobutane, 2,2-dihydroxy-1-thia-2-silacyclobutane, 2-methoxy-2-methyl-1-thia-2-silacyclobutane, 2,2-dimethoxy-1-thia-2-silacyclopentane, 2,2-diethoxy-1-thia-2-silacyclopentane, 2,2-di-n-propoxy-1-thia-2-silacyclopentane, 2,2-di-iso-propoxy-1-thia-2-silacyclopentane, 2,2-dibutyl-1-thia-2-silacyclopentane, 2,2-diphenoxy-1-thia-2-silacyclopentane, 2,2-divinyl-1-thia-2-silacyclopentane, 2,2-dihydroxy-1-thia-2-silacyclopentane, 2-methoxy-2-methyl-1-thia-2-silacyclopentane, 2,2-dimethoxy-1-thia-2-silacyclohexane, 2,2-diethoxy-1-thia-2-silacyclohexane, 2,2-di-n-propoxy-1-thia-2-silacyclohexane, 2,2-di-iso-propoxy-1-thia-2-silacyclohexane, 2,2-dibutyl-1-thia-2-silacyhexane, 2,2-diphenoxy-1-thia-2-silacyhexane, 2,2-divinyl-1-thia-2-silacyclohexane, 2,2-dihydroxy-1-thia-2-silacyclohexane, 2-methoxy-2-methyl-1-thia-2-silacyclohexane, 2,2-dimethoxy-1-thia-2-silacycloheptane, 2,2-diethoxy-1-thia-2-silacycloheptane, 2,2-di-n-propoxy-1-thia-2-silacycloheptane, 2,2-di-iso-propoxy-1-thia-2-silacycloheptane, 2,2-dibutyl-1-thia-2-silacycloheptane, 2,2-diphenoxy-1-thia-2-silacycloheptane, 2,2-divinyl-1-thia-2-silacycloheptane, 2,2-dihydroxy-1-thia-2-silacycloheptane, 2-methoxy-2-methyl-1-thia-2-silacycloheptane.

7. The process of claim 1, wherein the functionalized diene polymer contains up to 49% by weight based on the total weight of the polymer of units derived from one or more comonomers selected from one or more conjugated dienes having from 5 to 20 carbon atoms other than 1,3-butadiene and one or more vinylaromatic comonomers having from 8 to 30 carbon atoms and combinations thereof.

8. The process of claim 1, wherein the functionalized diene polymer has at least one or all of the following properties: a number-averaged molecular weight of from 100,000 to 1,000,000, determined by gel permeation chromatography with polystyrene calibration, a Mooney viscosity ML 1+4 at 100° C., determined according to DIN 52523/52524, of from 30 to 150 units and a glass transition temperature of from −110° C. to 0° C. determined by differential scanning calometry (DSC) from the 2^{nd} heating curve at a heating rate of 20 K/min.

9. The process of claim 1, wherein the thiol containing end group corresponds to the general formula (I) 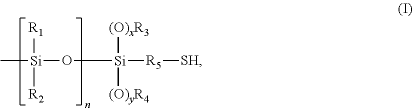
and the thiolate containing end group corresponds to the general formula (II) 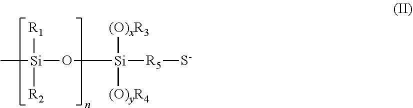
and a combination thereof,
wherein
n represents 1, 2, 3, 4, 5, 6, 7 or 8;
R₁, R₂, R₃ and R₄ represent, independently from each other and from each unit n, hydrogen or a hydrocarbon residue containing from 1 to 24 carbon atoms and wherein the hydrocarbon residue may be saturated or may contain at least one carbon-carbon double bond and wherein the hydrocarbon residue may be interrupted once or more than once by O, Si or S atoms and may contain one or more substituents selected from alkyl amino, alkyl Phosphino, alkyl silyl substituents and combinations thereof;
R₅ represents an alkylene group —[CXY]ₚ— wherein p is an integer selected from 2, 3, 4 or 5 and X and Y are selected independently from each other from H, or C₁-C₆ alkyl and each X and Y may be the same or different in each unit p, or the alkylene group is unsaturated in which case two neighbouring X, or two neighbouring Y, or one neighbouring X and one neighbouring Y jointly represent a carbon-carbon double bond;
x and y are selected independently from each other and either represent 0 or 1 with the proviso that the sum of x+y is either 1 or 2.

10. A functionalized diene polymer obtainable by the process of claim 1.

11. A composition comprising at least 90% by weight based on a total weight of the composition of the functionalized diene polymer obtainable by the process of claim 1.

12. A curable compound comprising at least 5% by weight based on a total weight of the compound of the functionalized diene polymer obtainable by the process of claim 1 and further comprising at least 10% by weight based on the total weight of the compound of at least one rubber other than the functionalized polymer, at least one filler or a combination thereof and wherein the curable compound, optionally, further comprises at least one curative for curing the functionalized butadiene polymer.

13. A method of making a curable compound comprising at least 5% by weight based on the total weight of the compound of the functionalized diene polymer obtainable by the process of claim 1 and further comprising at least 10% by weight based on the total weight of the compound of at least one rubber other than the functionalized polymer, at least one filler or a combination thereof and wherein the curable compound, optionally, further comprises at least one curative for curing the functionalized butadiene polymer, wherein the method comprises combining at least one functionalized diene polymer obtainable by the process of claim 1 with at least one filler or at least one rubber other than the functionalized diene polymer, or a combination thereof, and optionally at least one curative for curing the functionalized diene polymer.

14. An article comprising a curable compound comprising at least 5% by weight based on the total weight of the compound of the functionalized diene polymer obtainable by the process of claim 1 and further comprising at least 10% by weight based on the total weight of the compound of at least one rubber other than the functionalized polymer, at least one filler or a combination thereof and wherein the curable compound, optionally, further comprises at least one curative for curing the functionalized butadiene polymer, wherein the article is a tire or a rubber component of a tire and wherein the article comprises the compound in a cured form.

15. A method of making an article comprising subjecting a curable compound comprising at least 5% by weight based on the total weight of the compound of the functionalized diene polymer obtainable by the process of claim 1 and further comprising at least 10% by weight based on the total weight of the compound of at least one rubber other than the functionalized polymer, at least one filler or a combination thereof and wherein the curable compound, optionally, further comprises at least one curative for curing the functionalized butadiene polymer to curing and shaping wherein the shaping may be carried out prior to, after or during the curing.

16. A functionalized diene polymer terminated by a functional end group selected from a thiol-containing end group or a thiolate-containing end group corresponding to the general formula (I) or (II) 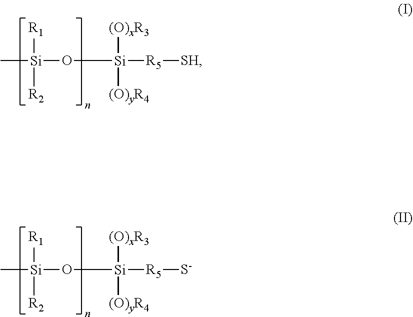
and a combination thereof,
wherein
R₁, R₂, R₃ and R₄ represent, independently from each other and from each unit n, hydrogen or a hydrocarbon residue containing from 1 to 24 carbon atoms and wherein the hydrocarbon residue may be saturated or may contain at least one carbon-carbon double bond and wherein the hydrocarbon residue may be interrupted once or more than once by O, Si or S atoms and may contain one or more substituents selected from alkyl amino, alkyl phosphino, alkyl silyl substituents and combinations thereof;
R₅ represents an alkylene group —[CXY]ₚ— wherein p is an integer selected from 2, 3, 4 or 5 and X and Y are selected independently from each other from H, or C₁-C₆ alkyl and each X and Y may be the same or different in each unit p, or the alkylene group is unsaturated in which case two neighbouring X, or two neighbouring Y, or one neighbouring X and one neighbouring Y jointly represent a carbon-carbon double bond;
n represents 1, 2, 3, 4, 5, 6, 7 or 8;
x and y are selected independently from each other and either represent 0 or 1 with the proviso that the sum of x+y is either 1 or 2;
wherein the thiol-terminated or thiolate-terminated diene polymer contains at least 51% by weight based on the total weight of the polymer of units derived from 1,3-butadiene.
